(19) United States
(12) Patent Application Publication
(10) Pub. No.: US 2021/0127686 A1
(43) Pub. Date: May 6, 2021

(54) LIQUID AND STORAGE-STABLE FORMULATIONS FOR FUNGAL SPORES

(71) Applicants: Bayer Aktiengesellschaft, Leverkusen (DE); BAYER CROPSCIENCE BIOLOGICS GMBH, Wismar (DE)

(72) Inventors: Ulrike HILSCHER, Wismar (DE); Oliver GAERTZEN, Köln (DE)

(73) Assignees: Bayer Aktiengesellschaft, Leverkusen (DE); BAYER CROPSCIENCE BIOLOGICS GMBH, Wismar (DE)

(21) Appl. No.: 17/251,128

(22) PCT Filed: Jun. 12, 2019
(86) PCT No.: PCT/EP2019/065308

§ 371 Date: Dec. 10, 2020

(30) Foreign Application Priority Data
Jun. 15, 2018 (EP) 18177986.9

(51) Int. Cl. A01N 63/30; A01N 25/02; A01N 25/22; A01N 65/20; A01N 31/08; A01N 55/00

(52) U.S. Cl. CPC A01N 63/30; A01N 25/02; A01N 55/00; A01N 65/20; A01N 31/08; A01N 25/22

(57) ABSTRACT

The present invention relates to formulation for fungal spores which increases storage stability of said fungal spores comprising a liquid water-soluble formulation comprising fungal spores, at least one plant oil, at least one antioxidant and optionally at least one rheology-modifying agent. Further, the invention relates to a method for controlling phytopathogenic fungi, insects and/or nematodes in or on a plant, for enhancing growth of a plant or for increasing plant yield or root health comprising applying an effective amount of the present formulation.

The use of plant protection formulations comprising biological control agents (BCAs) has become a valuable alternative in the field of plant protection. Biological control agents directed against fungi or insects as well as those promoting plant health have been put on the market in different formulations.

The provision of suitable formulations for biological control agents nevertheless still poses a challenge due to the many factors contributing to the efficacy of the final formulation such as nature of the biological control agent, temperature stability and shelf life as well as effects of the formulation in the application.

Suitable formulations are homogeneous and stable mixtures of active and inert ingredients which make the final product simpler, safer, and more efficacious to apply to a target. Commonly used additives in formulations of both chemical and biological plant protection agents include surfactants such as dispersants or wetting agents, solvents, emulsifiers, defoamers and stabilizers.

Commonly used formulations for biological control agents include WP, a solid formulation micronized to powder form and typically applied as suspended particles after dispersion in water, and WG, a formulation consisting of granules to be applied after disintegration and dispersion in water. The granules of a WG product has distinct particles within the range 0.2 to 4 mm. Water dispersible granules can be formed by agglomeration, spray drying, or extrusion techniques.

WP formulations are produced rather easily but they are dusty. Further, they are not easy to dose in the field. WG formulations are easier to handle for the user and in general have lower dust content than WP formulations.

An example for a liquid formulation is SC, a water-based suspension of solid active ingredient in a fluid usually intended for dilution with water before use. Another liquid formulation type is EC, a solution of active ingredient combined with surfactants like e. g. emulsifying agents in a water insoluble organic solvent which will form an emulsion when added to water. Such formulation tends to be more hazardous to the operator and the environment due to the organic solvents used.

An enormous number of formulants have been utilized in experimental and commercial formulations of biological control agents (for a more detailed description and list see Schisler et al., Phytopathology, Vol 94, No. 11, 2004). Generally, formulants can be grouped as either carriers (fillers, extenders) or formulants that improve the chemical, physical, physiological or nutritional properties of the formulated biomass.

It has generally been more difficult to obtain useful and viable formulations for biological control agents based on fungi, in particular fungal spores, as compared to those based on bacteria since the latter seem to be more robust and resistible. As an example, a comparison of formulations and their effect on Trichoderma harzianum can be found in Küçük and Kivaniç (African Journal of Biotechnology 2005, Vol. 4 (5), pp. 483-486).

Another example for a formulation of a biological control agent is described in Torres et al., 2003, J Appl Microbiol, 94(2), pp: 330-9). However, it is clear that a formulation preserving viability of the biological control agent, e. g. fungal spores, of more than 70% for 4 months at 4 degrees ° C. only is not suitable for everyday use in the field. Rather, it is desirable that formulations of biological control agents have a sufficient shelf life even under conditions where cold storage is not possible.

With the disadvantages described above there is still the need for a simple, easy to handle formulation recipe for biological control agents suitable both for foliar and soil application. Among other properties, such formulations shall ideally provide a good physical stability in the formulation concentrate, exhibit a suitable shelf life over time and ensure a superior distribution of the biological control agent both in spray and soil applications. Furthermore, the formulants shall preferably promote the biological efficacy of the BCA. Finally, the major ingredients of the formulation should preferably have low or better no impact on the environment.

Accordingly, in one embodiment, the present invention relates to a liquid water-soluble formulation comprising fungal spores, at least 25 wt.-% of at least one plant oil, at least 0.1 wt.-% of at least one antioxidant and optionally up to 5 wt.-% of a rheology modifier. The formulation preferably is a liquid water-miscible agricultural formulation.

Fungal spores include sexually (e. g. oospores, zygospores or ascospores) and asexually (e. g. conidia and chlamydospores, but also uredospores, teleutospores and ustospores) formed spores. Preferably the spores are conidia.

Plant oils or vegetable oils are oils derived from plant sources, as opposed to animal fats or petroleum. Among plant oils, the ones preferably used in the present invention are triglyceride-based vegetable oils which are liquid at least at room temperature, preferably also at temperatures below room temperature, such as at 15° C., at 10° C. or even at 5° C. or 4° C.

Concentrations of plant oil in the present formulation may range between 25 wt.-% and 90 wt.-%, preferably between 30 wt.-% and 85 wt.-%. Exemplary ranges include 40 wt.-% to 85 wt.-% and 50 wt.-% to 85 wt.-%, such as at least 40 wt.-%, at least 50 wt.-%, at least 60 wt.-% or at least 65 wt.%. More preferred concentrations are at least 65 wt.%, such as between 65 wt.-% and 85 wt.-% and any value in between. Most preferred concentrations are at least 75%, such as between 75 wt.% and 85 wt.% and any value in between.

The term “at least” indicates that in any case one agent as described is present in the formulation according to the invention. However, more than one such as (at least) two, (at least) three, (at least) four, (at least) 5 or even more such agents may be present in the formulation according to the invention.

Antioxidants inhibit oxidation of other molecules. Whereas Applicant does not wish to be bound by any scientific theory, it is believed that a certain concentration of antioxidant in the formulation of the invention contributes to the superior storage stability of the formulation, in particular the long stability of the fungal spores comprised therein.

The concentration of antioxidants in the formulation according to the present invention is at least 0.1 w.-% and may be increased to up to 5 wt.-%. A preferred range is between 0.15 wt.-% and 0.7 wt.-% such as 0.2 wt.-%, 0.3 wt.-%, 0.4 wt.-%, 0.5 wt.-% or 0.6 wt.-% or any other value in between this range.

The antioxidant may be any suitable antioxidant, but is preferably selected from the group consisting of butylhydroxytoluol (BHT), butylhydroxyanisole (BHA), ascorbyl palmitate, tocopheryl acetate, ascorbyl stearate or the group of carotinoids (e.g. beta-carotin) or gallates (e.g. ethyl gallate, propyl gallate, octyl gallate, dodecyl gallate).

In a more preferred embodiment, the antioxidant is butylhydroxytoluol which has been shown in the examples to contribute to the very good stability of the fungal spores in the formulation of the present invention. Further preferred, said butylhydroxytoluol is present in a concentration of between 0.1 wt.-% and 1 wt.-%, preferably between 0.2 wt.-% and 0.6 wt.-%.

Some plant oils naturally have a high content of antioxidants, e.g. wheat germ oil. In case such plant oil is used, the further addition of an antioxidant may not be necessary or the amount may be reduced in order to arrive at the concentrations described herein which are believed to be one factor responsible for the enhanced storage stability of the present formulation. Accordingly, for such plant oils with a high content of antioxidants, such as at least 0.4%, no addition of further antioxidant may be necessary. In such cases, the required percentage of antioxidant according to the invention is comprised in the minimum concentration of plant oil according to the invention.

The liquid preparation further comprises a rheology modifier. Rheology modifiers are preferably derived from minerals. These rheology modifiers provide long term stability when the formulation is at rest or in storage. Furthermore, it has been found in the course of the present invention that such rheology modifiers seem to contribute to the increased storage stability of the present formulation.

Suitable compounds are rheological modifiers selected from the group consisting of hydrophobic and hydrophilic fumed and precipitated silica particles, gelling clays including bentonite, hectorite, laponite, attapulgite, sepiolite, smectite, or hydrophobically/organophilic modified bentonite.

In connection with the present invention, fumed or precipitated silica is preferred as rheology modifier.

Fumed silica, also known as pyrogenic silica, either hydrophilic or hydrophobic, usually is composed of amorphous silica fused into branched, chainlike, three-dimensional secondary particles which then agglomerate into tertiary particles. The resulting powder has an extremely low bulk density and high surface area. Both hydrophilic and hydrophobic fumed silica can be used in the present invention

Fumed silica usually has a very strong thickening effect. The primary particle size is ca. 5-50 nm. The particles are non-porous and have a surface area of ca. 50-600 m²/g.

Hydrophilic fumed silica is made from flame pyrolysis of silicon tetrachloride or from quartz sand vaporized in a 3000° C. electric arc. Major global producers are Evonik Industries, tradename AEROSIL®); Cabot Corporation, tradename Cab-O-Sil®; Wacker Chemie, HDK product range; and OCI, tradename Konasil®.

Hydrophilic fumed silica can be hydrophobized by further treatment with reactive silicium-containing agents in order to modify the physicochemical properties of the silica. Typically hydrophobisation takes place by treatment of a hydrophilic fumed silica with agents like hexaalkyldisilanes (e.g. ((CH₃)₃Si)₂), trialkylsilylchlorides (e.g. (CH₃)₃SiCl) or dialkyldichlorsilanes (e.g. (CH₃)₂SiCl₂). Hydrophobized fumed silica is available e.g. from Evonik Industries (AEROSIL R-types), and Cabot (Cab-O-Sil).

Best results are obtained using a hydrophilic fumed silica having a BET surface area of 150 to 350 m²/g, e. g. 150, 200, 250, 300 or 350.

Precipitated silica is produced by acidifying aqueous alkaline silicate solutions with mineral acids. Variations of the precipitation process lead to different precipitated silica qualities namely with different specific surface areas. The precipitates are washed and dried. Precipitated silica having a particle size of below 10 μm are most effective for the present invention. The specific surface area is typically from ca. 50-500 m²/g. Global producers are for example Evonik Industries, tradename SIPERNAT® or Wessalon®; Rhodia, tradename Tixosil®; and PPG Industries, tradename Hi-Sil™.

Major global producers for fumed (pyrogenic) hydrophilic or hydrophbized silicas are Evonik (tradename Aerosil®), Cabot Corporation (tradename Cab-O-Sil®), Wacker Chemie (HDK product range), Dow Corning, and OCI (Konasil®). Another class of suitable rheology modifiers are precipitated silicas, and major global producers are Evonik (tradenames Sipernat® or Wessalon®), Rhodia (Tixosil) and PPG Industries (Hi-Sil).

Particularly preferred in connection with the present liquid preparation is fumed silica having a BET surface area of about 200 m²/g obtainable e.g. as Aerosil® 200.

Another class of suitable examples for rheology modifiers are clay thickeners. Clay thickeners are generally micronized layered silicates that can be effective thickeners for a wide range of applications. They are typically employed either in their non-hydrophobized or hydrophobized form. In order to make them dispersible in non-aqueous solvents, the clay surface is usually treated with quaternary ammonium salts. These modified clays are known as organo-modified clay thickeners. Optionally, small amounts of alcohols of low molecular weight or water may be employed as activators. Examples for such clay-based rheology modifiers include smectite, bentonite, hectorite, attapulgite, seipiolite or montmorillonite clays. Preferred rheological modifiers (b) are for example organically modified hectorite clays such as Bentone® 38 and SD3. organically modified bentonite clays, such as Bentone® 34, SD1 and SD2, organically modified sepiolite such as Pangel® B20, hydrophilic silica such as Aerosil® 200, hydrophobic silica such as Aerosil® R972, R974 and R812S, attapulgite such as Attagel® 50,

Another class of suitable examples for rheology modifiers are organic rheological modifiers based on modified hydrogentated castor oil (trihydroxystearin) or castor oil organic derivatives such as Thixcin® R and Thixatrol® ST.

Physical properties of selected compounds

| Tradename | Company | General description | Physical propeties | CAS- No. |
|---|---|---|---|---|
| Bentone ® 38 | Elementis | Organic derivative of | Density: 1.7 g/cm³ | 12001-31-9 |
| | Specialties, US | a hectorite clay | | |
| Bentone ® SD-3 | Elementis | Organic derivative of | Density: 1.6 g/cm³ | |
| | Specialties, US | a hectorite clay | Particle size | |
| | | | (dispersed): <1 μm | |
| Bentone ® 34 | Elementis | Organic derivative of | Density: 1.7 g/cm³ | 68953-58-2 |
| | Specialties, US | a bentonite clay | | |
| Bentone ® SD-1 | Elementis | Organic derivative of | Density: 1.47 g/cm³ | 89749-77-9 |
| | Specialties, US | a bentonite clay | | |
| Bentone ® SD-2 | Elementis | Organic derivative of | Density: 1.62 g/cm³ | 89749-78-0 |
| | Specialties, US | a bentonite clay | | |
| Pangel ® B20 | Tolsa S.A., ES | Organically modified | | 63800-37-3 |
| | | sepiolite | | |
| Sipernat ® 22S | Evonik | Precipitated | *BET: 190 m²/g | 112926-00-8 |
| | Industries AG, | amorphous silicon | Average primary | |
| | DE | dioxide | particle size: 12 nm | |
| Aerosil ® 200 | Evonik | Hydrophilic fumed | *BET: 200 m²/g | 112945-52- |
| | Industries AG, | silica | Average primary | 57631-86-9 |
| | DE | | particle size: 12 nm | |
| Aerosil ® R 972/ | Evonik | Hydrophilic fumed | *BET: 90-130 m²/g | 68611-44-9 |
| R972V | Industries AG, | silica | | |
| | DE | | | |
| Aerosil ® R 974 | Evonik | Hydrophilic fumed | *BET: 150-190 m²/g | 68611-44-9 |
| | Industries AG, | silica | | |
| | DE | | | |
| Aerosil ® R 812S | Evonik | Hydrophilic fumed | *BET: 260 ± 30 m²/g | 68909-20-6 |
| | Industries AG, | silica | | |
| | DE | | | |
| Attagel ® 50 | BASF AG, DE | Attapulgite clay: | Density: >1.0 g/cm³ | 14808-60-7 |
| | | (Mg, Al)₅Si₈O₂₀•4H₂O | Average particle size: 9 μm | |
| Thixcin ® R | Elementis | organic derivative of | Density: 1.02 g/cm³ | 38264-86-7 |
| | Specialties, US | castor oil | | |
| Thixatrol ® ST | Elementis | organic derivative of | Density: 1.02 g/cm³ | 51796-19-1 |
| | Specialties, US | castor oil, | | |
| | | Octadecanamide | | |

Said rheology-modifying agent may be present in the formulation of the invention in a concentration of up to 7 wt.-%, preferably between 1.5 wt-% and 4 wt-%, more preferably between 2 wt-% and 3 wt-%, such as about 2.1 wt-%, about 2.2 wt-%, about 2.3 wt-%, about 2.4 wt-%, about 2.5 wt-%, about 2.6 wt-%, about 2.7 wt-%, about 2.8 wt-% or about 2.9 wt-%.

The term “about”, whenever used in connection with the present invention, relates to the mentioned sumerical value +/−10%.

The formulation may in addition comprise a polyether-modified trisiloxane which is preferably of formula I

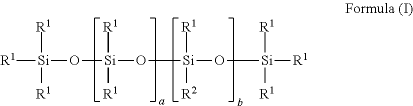

where

R¹ represents independent from each other identical or different hydrocarbyl radicals having 1-8 carbon atoms, preferred methyl-, ethyl-, propyl- and phenyl radicals, particularly preferred are methyl radicals.

a=0 to 1, preferred 0 to 0.5, particularly preferred 0,

b=0.8 to 2, preferred 1 to 1.2, particularly preferred 1,

in which: a+b<4 and b>a, preferred a+b<3 and particularly preferred a+b<2.

R² represents independent from each other identical or different polyether radicals of general formula (II)

—R³O[CH₂CH₂O]_{c}[CH₂CH(CH₃)O]_{d}[CHR⁴CHR⁴O]_{c}R⁵ Formula (II)

R³=independent from each other identical or different, bivalent hydrocarbyl radicals having 2-8 carbon atoms, which are optionally interrupted by oxygen atoms, preferred rest is the general formula (III) where n=2-8, particularly preferred —CH₂—CH₂—CH₂—,

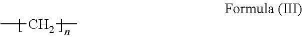

R⁴=independent from each other identical or different hydrocarbyl radicals having 1-12 carbon atoms or hydrogen radical, preferably a methyl-, ethyl-, phenyl- or a hydrogen radical.

R⁵=independent from each other identical or different hydrocarbyl radicals having 1-16 carbon atoms, which are optionally contain urethane functions, carbonyl functions or carboxylic acid ester functions, or hydrogen radical, preferred methyl or H, particularly preferred H.

C=0 to 40, preferred 1 to 15, particularly preferred 2 to 10

d=0 to 40, preferred 0 to 10, particularly preferred 1 to 5

e=0 to 10, preferred 0 to 5, particularly preferred 0,

in which c+d+e>3

The polyether-modified trisiloxanes described above can be prepared by methods well known to the practioner by hydrosilylation reaction of a Si—H containing siloxane and unsaturated polyoxyalkylene derivatives, such as an allyl derivative, in the presence of a platinum catalyst. The reaction and the catalysts employed have been described for example, by W. Noll in “Chemie and Technologie der Silicone”, 2^{nd} ed., Verlag Chemie, Weinheim (1968), by B. Marciniec in “Appl. Homogeneous Catal. Organomet. Compd. 1996, 1, 487). It is common knowledge that the hydrosilylation products of SiH-containing siloxanes with unsaturated polyoxyalkylene derivatives can contain excess unsaturated polyoxyalkylene derivative.

Examples of water soluble or self-emulsifyable polyether-modified (PE/PP or block-CoPo PEPP) trisiloxanes include but are not limited to those described by CAS-No 27306-78-1 (e.g. Silwet L77 from MOMENTIVE), CAS-No 134180-76-0 (e.g. BreakThru S233 or BreakThru S240 from Evonik), CAS-No 67674-67-3 (e.g Silwet 408 from WACKER), other BreakThru-types, and other Silwet-types.

Preferred polyether-modified trisiloxanes include those described by CAS-No 134180-76-0, in particular Break-Thru S240. In one preferred embodiment, the polyether-modified trisiloxane has the chemical denomination oxirane, mono(3-(1,3,3,3-tetramethyl-1-((trimethylsilyl)oxy)disiloxanyl)propyl)ether. It is most preferred that the polyether-modified trisiloxane is Breakthru S240.

The amount of polyether-modified trisiloxane, if present in the formulation, is at least 5 wt.-%, such as at least 10 wt.-% or at least 20 wt.-%. Preferably, the amount of polyether.modified trisiloxane ranges between 5 and 40 wt.-%, preferably 5 and 30 wt.-%. In certain embodiments, an amount of between 5 and 15 wt.-% will be optimal. Exemplary values include at least about 5 wt.-%, at least about 6 wt.-%, at least about 7 wt.-%, at least about 8 wt.-%, at least about 9 wt.-%, at least about 10 wt.-%, at least about 11 wt.-%, at least about 12 wt.-%, at least about 13 wt.-%, at least about 14 wt.-% and at least about 15 wt.-%.

The present formulation is preferably essentially free of water.

The formulation types described supra were mainly developed for agrochemicals and not for biological control agents such as fungi where the requirements differ already due to the fact that such BCAs are living organisms in a dormant form. Furthermore, stability requirements for BCAs as compared to conventional agrochemicals are generally more demanding. Accordingly, formulations comprising a low concentration of water or even being essentially free of water are a preferred formulation type for BCAs. If water is present, such water mainly comes from water in the dried spore powder or traces of water in the other formulants. Accordingly, the water concentration highly depends on the amount of spore powder mixed into the composition of the invention. The higher the amount of spore powder the higher the water content may be. Water concentrations of between 0.3 wt.-% and 8 wt.-%, such as 0.3 wt.-% and 5 wt.-%, or between 4 wt.-% and 7 wt.-% are possible due to these facts, which range would then fall within the definition of “essentially free of water”. The amount of spore powder in the formulation according to the invention also depends on the application type and indication. Accordingly, exemplary water concentrations include 1%, 2%, 3%, 4%, 5%, 6%, 7% and 8% which all fall within the definition of “essentially free of water”. In other words, “essentially free of water” means a water content in the formulation according to the invention of 8% or less, preferably 7% or less, even more preferably 5% or less. This water content of 8 wt.-% or less of the formulation is also denominated “residual water”. As indicated above, such residual water is comprised in the ingredients of the formulation of the invention which means that it is not added as a separate ingredient. Accordingly, the residual water content of the formulation of the invention is 8 wt.-% or less, such as any of the above values. Whereas the added percentages of fungal spores, polyether-modified trisiloxane and other ingredients shall not exceed 100%, the residual water content may be given in the formulation of the invention without adding up to the former ingredients due to said “residual water” being comprised in the other ingredients.

The water content of the spore powder prior to addition into the formulation according to the invention may be measured according to methods well-known in the art, e.g. using a moisture analyzer such as one available from Sartorius (Type MA 30). Using this moisture analyzer two samples of between 1 and 4 g out of a spore preparation are taken. The moisture analyzer is adjusted to a temperature of 105° C. and the respective amount of spore powder applied.

In a preferred embodiment the fungal spores are from a fungal microorganism that exhibits activity against insects (insecticide), acarids (acaricide), nematodes (nematicide), molluscs (molluscicide), bacteria (bactericide), rodents (rodenticide), weeds (herbicide) and/or phytopathogens (e. g. fungicide).

“Insecticides” as well as the term “insecticidal” refers to the ability of a substance to increase mortality or inhibit growth rate of insects. As used herein, the term “insects” includes all organisms in the class “Insecta”. The term “pre-adult insects” refers to any form of an organism prior to the adult stage, including, for example, eggs, larvae, and nymphs.

“Acaricide” as well as the term “acaricidal” refer to the ability of a substance to increase mortality or inhibit growth rate of acarides, e.g. ticks and mites.

“Nematicides” and “nematicidal” refers to the ability of a substance to increase mortality or inhibit the growth rate of nematodes. In general, the term “nematode” comprises eggs, larvae, juvenile and mature forms of said organism.

Biological control agents, such as those based on fungal spores, active against phytopathogens such as phytopathogenic fungi are suitable to increase mortality or inhibit growth rate of phytopathogens such as phytopathogenic fungi or viruses.

Biological control agents, such as those based on fungal spores, active against molluscs are suitable to increase mortality or inhibit growth rate of molluscs such as snails and slugs.

Biological control agents, such as those based on fungal spores, active against rodents are suitable to increase mortality or inhibit growth rate of rodents.

Biological control agents, such as those based on fungal spores, active against weeds are suitable to increase mortality or inhibit growth rate of weeds.

In one embodiment the formulation further comprises at least one synthetic plant protective agent provided such synthetic plant protective agent does not adversely affect the activity of the biological control agent.

Synthetic plant protective agents in connection with the present invention include chemical fungicides, insecticides, bactericides, miticides, acaricides, molluscicides, rodenticides and herbicides as well as safeners and growth enhancing agents.

Chemical fungicides include those belonging to the class inhibitors of the ergosterol biosynthesis, inhibitors of the respiratory chain at complex I, II or III, inhibitors of the mitosis and cell division and compounds to have a multisite action, compounds capable to introduce a host defence, inhibitors of the amino acid and/or protein biosynthesis, inhibitors of the ATP production, inhibitors of the cell wall synthesis, inhibitors of the lipid and membrane synthesis, inhibitors of the melanine biosynthesis, inhibitors of the nucleic acid synthesis, inhibitors of the signal transduction, compounds capable to act as an uncoupler, and other fungicides.

Chemical insecticides include those belonging to the class of acetylcholinesterase (AChE) inhibitors, nicotinic acetylcholine receptor (nAChR) agonists, nicotinic acetylcholine receptor (nAChR) allosteric activators, nicotinic acetylcholine receptor (nAChR) channel blockers and ryanodine receptor modulators, GABA-gated chloride channel antagonists and chloride channel activators, sodium channel modulators/voltage-dependent sodium channel blockers and voltage-dependent sodium channel blockers, juvenile hormone mimics, miscellaneous non-specific (multi-site) inhibitors, selective homopteran feeding blockers, mite growth inhibitors, microbial disruptors of insect midgut membranes, inhibitors of mitochondrial ATP synthase, uncouplers of oxidative phoshorylation via disruption of the proton gradient, inhibitors of chitin biosynthesis (type 0), inhibitors of chitin biosynthesis (type 1), moulting disruptors, ecdysone receptor agonists, octopamine receptor agonists, mitochondrial complex III electron transport inhibitors, mitochondrial complex I electron transport inhibitors, inhibitors of acetyl CoA carboxylase, mitochondrial complex IV electron transport inhibitors, mitochondrial complex II electron transport inhibitors, and further insecticides

In a preferred embodiment, the fungal spores are conidia. Conidia are a kind of spores formed by fungi. Conidia are asexually formed and include but are not limited to aleurispores, anellospores, arthrospores, phialospores and pynidiospores. Conidia are not intended to survive very harsh environmental conditions.

In some embodiments, the conidia are hydrophobic.

In another embodiment, the fungal spores are chlamydospores.

In one embodiment, the fungal spores are sexually formed. Sexually formed spores which can be used in the present invention include oospores, zygospores or ascospores.

In another more preferred embodiment said spores are dried spores.

This means that after fermentation the spores are subjected to a drying process.

The fungal microorganism acting as biological control agent giving rise to the fungal spores is cultivated according to methods known in the art or as described elsewhere in this application on an appropriate substrate, e. g. by submerged fermentation or solid-state fermentation, e. g. using a device disclosed in WO2005/012478 or WO1999/057239, or liquid fermentation as disclosed e.g. in WO 2009/035925.

After solid fermentation, the spores are separated from the substrate. The substrate populated with the spores may be dried before or after separation of the spores from the substrate. The spores may be dried via e. g. freeze-drying, vacuum drying or spray drying after separation. After separation and drying, the spores are suspended in a preparation comprising all ingredients according to the invention except the spores.

After cultivation/fermentation and prior to separation, the culture substrate may be treated with an appropriate dispersion method. Alternatively, after drying the culture is treated by an appropriate grinding method. In this case, separation takes place after the treatment step through methods known in the art such as sieving, filtration, air classifying, decantation or centrifugation methods.

In yet another preferred embodiment said fungal spores are present in the formulation according to the invention in a concentration of between at least about 1×10⁵ viable spores/gram formulation and about 7.5×10¹⁰ viable spores/gram formulation

Accordingly, fungal spores may be present in a concentration of e.g. at least about 1×10⁵ viable spores/gram formulation, at least about 1×10⁶ viable spores/gram formulation, at least about 5×10⁶ viable spores/gram formulation, at least about 1×10⁷ viable spores/gram formulation, at least about 5×10⁷ viable spores/gram formulation, at least about 1×10⁸ viable spores/gram formulation, at least about 5×10⁸ viable spores/gram formulation, at least about 1×10⁹ viable spores/gram formulation or at least about 2×10⁹ viable spores/gram formulation, at least 5×10⁹ viable spores/gram formulation, at least 1×10¹⁰ viable spores/gram formulation or at least 2×10¹⁰ viable spores/gram formulation, even at least 3×10¹⁰ viable spores/gram formulation, all depending on the requirements of the application. Chlamydospores may be present in a concentration of e.g. about 5×10⁶ viable spores/gram formulation, 1×10⁷ viable spores/gram formulation, 5×10⁷ viable spores/gram formulation, 1×10⁸ viable spores/gram formulation or 5×10⁸ viable spores/gram formulation, all depending on the requirements of the application.

Depending on the size of the spores used and the desired spore concentration in the composition, different amounts of spore powder need to be used. Exemplary percentages range from 0.5 wt.-% to 40 wt.-%, such as about 10 wt.-%, about 15 wt.-%, about 20 wt.-%, about 25 wt.-% or about 30 wt.-%. The skilled person is aware that for particularly big spores, the maximum spores concentration indicated may not be reachable, and will adapt the teaching according to the invention to the spores used.

The plant oil may be any plant oil. However, preferred plant oils include wheat germ oil, and soybean oil, peanut oil, rice bran oil, saflor oil, rapeseed oil, sunflower oil, corn oil, walnut oil, hazelnut oil, almond oil or olive oil.

In a more preferred embodiment, said plant oil is soybean oil.

If the fungal spores or the fungus growing from said fungal spores have a fungicidal effect, it may be selected from

Fungi active against fungal pathogens are e.g. B2.1 Coniothyrium minitans, in particular strain CON/M/91-8 (Accession No. DSM-9660; e.g. Contans® from Bayer CropScience Biologics GmbH); B2.2 Metschnikowia fructicola, in particular strain NRRL Y-30752; B2.3 Microsphaeropsis ochrace, in particular strain P130A (ATCC deposit 74412); B2.4 Muscodor albus, in particular strain QST 20799 (Accession No. NRRL 30547); B2.5 Trichoderma harzianum rifai, in particular strain KRL-AG2 (also known as strain T-22,/ATCC 208479, e.g. PLANTSHIELD T-22G, Rootshield®, and TurfShield from BioWorks, US) and strain T39 (e.g. Trichodex® from Makhteshim, US); B2.6 Arthrobotrys dactyloides; B2.7 Arthrobotrys oligospora; B2.8 Arthrobotrys superba; B2.9 Aspergillus flavus, in particular strain NRRL 21882 (e.g. Afla-Guard® from Syngenta) or strain AF36 (e.g. AF36 from Arizona Cotton Research and Protection Council, US); B2.10 Gliocladium roseum, in particular strain 321U from W.F. Stoneman Company LLC or strains CRrO, CRM and CRr2 disclosed in WO2017109802; B2.11 Phlebiopsis (or Phlebia or Peniophora) gigantea, in particular strain VRA 1835 (ATCC 90304), strain VRA 1984 (DSM16201), strain VRA 1985 (DSM16202), strain VRA 1986 (DSM16203), strain FOC PG B20/5 (IMI390096), strain FOC PG SP log 6 (IMI390097), strain FOC PG SP log 5 (IMI390098), strain FOC PG BU3 (IMI390099), strain FOC PG BU4 (IMI390100), strain FOC PG 410.3 (IMI390101), strain FOC PG 97/1062/116/1.1 (IMI390102), strain FOC PG B22/SP1287/3.1 (IMI390103), strain FOC PG SH1 (IMI390104) and/or strain FOC PG B22/SP1190/3.2 (IMI390105) (Phlebiopsis products are e.g. Rotstop® from Verdera and FIN, PG-Agromaster®, PG-Fungler®, PG-IBL®, PG-Poszwald® and Rotex® from e-nema, DE); B2.12 Pythium oligandrum, in particular strain DV74 or M1 (ATCC 38472; e.g. Polyversum from Bioprepraty, CZ); B2.13 Scleroderma citrinum; B2.14 Talaromyces flavus, in particular strain V117b; B2.15 Trichoderma asperellum, in particular strain ICC 012 from Isagro or strain SKT-1 (e.g. ECO-HOPE® from Kumiai Chemical Industry), strain T34 (e.g. T34 Biocontrol by Biocontrol Technologies S.L., ES); B2.16 Trichoderma atroviride, in particular strain CNCM 1-1237 (e.g. Esquive® WP from Agrauxine, FR), strain SC1 described in International Application No. PCT/IT2008/000196 (e.g. Vintec from Belchim Crop Protection), strain 77B (T77 from Andermatt Biocontrol), strain no. V08/002387, strain NMI no. V08/002388, strain NMI no. V08/002389, strain NMI no. V08/002390, strain LC52 (e.g. Sentinel from Agrimm Technologies Limited), strain LUI32 (e.g. Tenet by Agrimm Technologies Limited), strain ATCC 20476 (IMI 206040), strain T11 (IMI352941/CECT20498), strain SKT-1 (FERM P-16510), strain SKT-2 (FERM P-16511), strain SKT-3 (FERM P-17021); B2.17 Trichoderma harmatum; B2.18 Trichoderma harzianum, in particular, strain KD, strain ITEM 908 (e.g. Trianum-P from Koppert), strain TH35 (e.g. Root-Pro by Mycontrol), strain DB 103 (e.g. T-Gro 7456 by Dagutat Biolab); B2.19 Trichoderma virens (also known as Gliocladium virens), in particular strain GL-21 (e.g. SoilGard by Certis, US); B2.20 Trichoderma viride, in particular strain TV1(e.g. Trianum-P by Koppert), strain B35 (Pietr et al., 1993, Zesz. Nauk. A R w Szczecinie 161: 125-137); B2.21 Ampelomyces quisqualis, in particular strain AQ 10 (e.g. AQ 10® by CBC Europe, Italy); B2.22 Arkansas fungus 18, ARF; B2.23 Aureobasidium pullulans, in particular blastospores of strain DSM14940, blastospores of strain DSM 14941 or mixtures of blastospores of strains DSM14940 and DSM 14941 (e.g. Botector® by bio-ferm, CH); B2.24 Chaetomium cupreum (e.g. BIOKUPRUM TM by AgriLife); B2.25 Chaetomium globosum (e.g. Rivadiom by Rivale); B2.26 Cladosporium cladosporioides, in particular strain H39 (by Stichting Dienst Landbouwkundig Onderzoek); B2.27 Dactylaria candida; B2.28 Dilophosphora alopecuri (e.g. Twist Fungus); B2.29 Fusarium oxysporum, in particular strain Fo47 (e.g. Fusaclean by Natural Plant Protection); B2.30 Gliocladium catenulatum (Synonym: Clonostachys rosea f. catenulate), in particular strain J1446 (e.g. Prestop® by Verdera Oy), strain IK726, strain 88-710 (WO2007/107000), strain CR7 (WO2015/035504); B2.31 Lecanicillium lecanii (formerly known as Verticillium lecanii), in particular conidia of strain KV01 (e.g. Vertalec® by Koppert/Arysta); B2.32 Penicillium vermiculatum; B2.33 Trichoderma gamsii (formerly T. viride), in particular strain ICC080 (IMI CC 392151 CABI, e.g. BioDerma by AGROBIOSOL DE MEXICO, S.A. DE C.V.); B2.34 Trichoderma polysporum, in particular strain IMI 206039 (e.g. Binab TF WP by BINAB Bio-Innovation AB, Sweden); B2.35 Trichoderma stromaticum (e.g. Tricovab by Ceplac, Brazil); B2.36 Tsukamurella paurometabola, in particular strain C-924 (e.g. HeberNem®); B2.37 Ulocladium oudemansii, in particular strain HRU3 (e.g. Botry-Zen® by Botry-Zen Ltd, NZ); B2.38 Verticillium albo-atrum (formerly V. dahliae), in particular strain WCS850 (CBS 276.92; e.g. Dutch Trig by Tree Care Innovations); B2.39 Muscodor roseus, in particular strain A3-5 (Accession No. NRRL 30548); B2.40 Verticillium chlamydosporium; B2.41 mixtures of Trichoderma asperellum strain ICC 012 and Trichoderma gamsii strain ICC 080 (product known as e.g. BIO-TAM™ from Bayer CropScience LP, US), B2.42 Simplicillium lanosoniveum and B2.43 Trichoderma fertile (e.g. product TrichoPlus from BASF).

In a preferred embodiment, the biological control agent having fungicidal activity is selected from

Coniothyrium minitans, in particular strain CON/M/91-8 (Accession No. DSM-9660) (available as Contans® from Prophyta, Del.); Microsphaeropsis ochracea strain P130A (ATCC 74412); Aspergillus flavus, strain NRRL 21882 (available as Afla-Guard® from Syngenta) and strain AF36 (available as AF36 from Arizona Cotton Research and Protection Council, US); Gliocladium roseum, strain 321U from Adjuvants Plus; Talaromyces flavus, strain VII7b; Ampelomyces quisqualis, in particular strain AQ 10 (available as AQ 10® by IntrachemBio Italia); Gliocladium catenulatum (Synonym: Clonostachys rosea f. catenulate), in particular strain J1446 (e.g. Prestop® by Verdera Oy), strain IK726, strain 88-710 (WO2007/107000), strain CR7 (WO2015/035504), Trichoderma viride, in particular strain TV1 (e.g. Trianum-P by Koppert), strain B35 (Pietr et al., 1993, Zesz. Nauk. A R w Szczecinie 161: 125-137), Trichoderma atroviride, in particular strain CNCM I-1237 (e.g. Esquive® WP from Agrauxine, FR), strain SC1 described in International Application No. PCT/IT2008/000196), strain 77B (T77 from Andermatt Biocontrol), strain no. V08/002387, strain NMI no. V08/002388, strain NMI no. V08/002389, strain NMI no. V08/002390, strain LC52 (e.g. Sentinel from Agrimm Technologies Limited), strain LUI32 (e.g. Tenet by Agrimm Technologies Limited), strain ATCC 20476 (IMI 206040), strain T11 (IMI352941/CECT20498), strain SKT-1 (FERM P-16510), strain SKT-2 (FERM P-16511), strain SKT-3 (FERM P-17021) and Cladosporium cladosporioides, e. g. strain H39 (by Stichting Dienst Landbouwkundig Onderzoek).

In an even more preferred embodiment, the biological control agent having fungicidal activity is selected from Coniothyrium minitans, in particular strain CON/M/91-8 (Accession No. DSM-9660) (available as Contans® from Prophyta, Del.); Gliocladium catenulatum (Synonym: Clonostachys rosea f. catenulate), in particular strain J1446 (e.g. Prestop® by Verdera Oy), strain IK726, strain 88-710 (WO2007/107000), strain CR7 (WO2015/035504); Trichoderma viride, in particular strain TV1 (e.g. Trianum-P by Koppert), strain B35 (Pietr et al., 1993, Zesz. Nauk. A R w Szczecinie 161: 125-137) and Trichoderma atroviride, in particular strain CNCM I-1237 (e.g. Esquive® WP from Agrauxine, FR), strain SC1 described in International Application No. PCT/IT2008/000196), strain 77B (T77 from Andermatt Biocontrol).

If the fungal spores or the fungus growing from said fungal spores have an insecticidal effect (entomopathogenic fungus), it may be selected from C2.1 Muscodor albus, in particular strain QST 20799 (Accession No. NRRL 30547); C2.2 Muscodor roseus in particular strain A3-5 (Accession No. NRRL 30548); C2.3 Beauveria bassiana, in particular strain ATCC 74040 (e.g. Naturalis® from CBC Europe, Italy; Contego BB from Biological Solutions Ltd.; Racer from AgriLife); strain GHA (Accession No. ATCC74250; e.g. BotaniGuard Es and Mycotrol-O from Laverlam International Corporation); strain ATP02 (Accession No. DSM 24665); strain PPRI 5339 (e.g. BroadBand™ from BASF); strain PPRI 7315, strain R444 (e.g. Bb-Protec from Andermatt Biocontrol), strains IL197, IL12, IL236, IL10, IL131, IL116 (all referenced in Jaronski, 2007. Use of Entomopathogenic Fungi in Biological Pest Management, 2007: ISBN: 978-81-308-0192-6), strain Bv025 (see e.g. Garcia et al. 2006. Manejo Integrado de Plagas y Agroecologia (Costa Rica) No. 77); strain BaGPK; strain ICPE 279, strain CG 716 (e.g. BoveMax® from Novozymes); C2.4 Hirsutella citriformis; C2.5 Hirsutella thompsonii (e.g. Mycohit and ABTEC from Agro Bio-tech Research Centre, IN); C2.6 Lecanicillium lecanii (formerly known as Verticillium lecanii), in particular conidia of strain KV01 (e.g. Mycotal® and Vertalec® from Koppert/Arysta), strain DAOM198499 or strain DAOM216596; C2.9 Lecanicillium muscarium (formerly Verticillium lecanii), in particular strain VE 6/CABI(=IMI) 268317/CBS102071/ARSEF5128 (e.g. Mycotal from Koppert); C2.10 Metarhizium anisopliae var acridum, e.g. ARSEF324 from GreenGuard by Becker Underwood, US or isolate IMI 330189 (ARSEF7486; e.g. Green Muscle by Biological Control Products); C2.11 Metarhizium brunneum, e.g. strain Cb 15 (e.g. ATTRACAP® from BIOCARE); C2.12 Metarhizium anisopliae, e.g. strain ESALQ 1037 (e.g. from Metarril® SP Organic), strain E-9 (e.g. from Metarril® SP Organic), strain M206077, strain C4-B (NRRL 30905), strain ESC1, strain 15013-1 (NRRL 67073), strain 3213-1 (NRRL 67074), strain C20091, strain C20092, strain F52 (DSM3884/ATCC 90448; e.g. BIO 1020 by Bayer CropScience and also e.g. Met52 by Novozymes) or strain ICIPE 78; C2.15 Metarhizium robertsii 23013-3 (NRRL 67075); C2.13 Nomuraea rileyi; C2.14 Paecilomyces fumosoroseus (new: Isaria fumosorosea), in particular strains Apopka 97 (available as PreFeRal from Certis, USA), Fe9901 (available as NoFly from Natural industries, USA), ARSEF 3581, ARSEF 3302, ARSEF 2679 (ARS Collection of Entomopathogenic Fungal Cultures, Ithaca, USA), IfB01 (China Center for Type Culture Collection CCTCC M2012400), ESALQ1296, ESALQ1364, ESALQ1409 (ESALQ: University of Sao Paulo (Piracicaba, SP, Brazil)), CG1228 (EMBRAPA Genetic Resources and Biotechnology (Brasilia, DF, Brazil)), KCH J2 (Dymarska et al., 2017; PLoS one 12(10)): e0184885), HIB-19, HIB-23, HIB-29, HIB-30 (Gandarilla-Pacheco et al., 2018; Rev Argent Microbiol 50: 81-89), CHE-CNRCB 304, EH-511/3 (Flores-Villegas et al., 2016; Parasites & Vectors 2016 9:176 doi: 10.1186/s13071-016-1453-1), CHE-CNRCB 303, CHE-CNRCB 305, CHE-CNRCB 307 (Gallou et al., 2016; fungal biology 120 (2016) 414-423), EH-506/3, EH-503/3, EH-520/3, PFCAM, MBP, PSMB1 (National Center for Biololgical Control, Mexico; Castellanos-Moguel et al., 2013; Revista Mexicana De Micologia 38: 23-33, 2013), RCEF3304 (Meng et al., 2015; Genet Mol Biol. 2015 July-September; 38(3): 381-389), PF01-N10 (CCTCC No. M207088), CCM 8367 (Czech Collection of Microorganisms, Brno), SFP-198 (Kim et al., 2010; Wiley Online: DOI 10.1002/ps.2020), K3 (Yanagawa et al., 2015; J Chem Ecol. 2015; 41(12): 118-1126), CLO 55 (Ansari Ali et al., 2011; PLoS One. 2011; 6(1): e16108. DOI: 10.1371/journal.pone.0016108), IfTS01, IfTS02, IfTS07 (Dong et al. 2016/PLoS ONE 11(5): e0156087. doi:10.1371/journal.pone.0156087), P1 (Sun Agro Biotech Research Centre, India), If-02, If-2.3, If-03 (Farooq and Freed, 2016; DOI: 10.1016/j.bjm.2016.06.002), Ifr AsC (Meyer et al., 2008; J. Invertebr. Pathol. 99:96-102. 10.1016/j.jip.2008.03.007), PC-013 (DSMZ 26931), P43A, PCC (Carrillo-Pérez et al., 2012; DOI 10.1007/s11274-012-1184-1), Pf04, Pf59, Pf109 (KimJun et al., 2013; Mycobiology 2013 December; 41(4): 221-224), FG340 (Han et al., 2014; DOI: 10.5941/MYCO.2014.42.4.385), Pfr1, Pfr8, Pfr9, Pfr10, Pfr11, Pfr12 (Angel-Sahagún et al., 2005; Journal of Insect Science), Ifr531 (Daniel and Wyss, 2009; DOI 10.1111/j.1439-0418.2009.01410.x), IF-1106 (Insect Ecology and Biocontrol Laboratory, Shanxi Agricultural University), I9602, I7284 (Hussain et al. 2016, DOI:10.3390/ijms17091518), I03011 (Patent U.S. Pat. No. 4,618,578), CNRCB1 (Centro Nacional de Referencia de Control Biologico (CNRCB), Colima, Mexico), SCAU-IFCF01 (Nian et al., 2015; DOI: 10.1002/ps.3977), PF01-N4 (Engineering Research Center of Biological Control, SCAU, Guangzhou, P. R. China) Pfr-612 (Institute of Biotechnology (IB-FCB-UANL), Mexico), Pf-Tim, Pf-Tiz, Pf-Hal, Pf-Tic (Chan-Cupul et al. 2013, DOI: 10.5897/AJMR12.493); C2.15 Aschersonia aleyrodis; C2.16 Beauveria brongniartii (e.g. Beaupro from Andermatt Biocontrol AG); C2.17 Conidiobolus obscurus; C2.18 Entomophthora virulenta (e.g. Vektor from Ecomic); C2.19 Lagenidium giganteum; C2.20 Metarhizium flavoviride; C2.21 Mucor haemelis (e.g. BioAvard from Indore Biotech Inputs & Research); C2.22 Pandora delphacis; C2.23 Sporothrix insectorum (e.g. Sporothrix Es from Biocerto, BR); C2.24 Zoophtora radicans.

In a more preferred embodiment, fungal strains having an insecticidal effect may be selected from C2.3 Beauveria bassiana, in particular strain ATCC 74040; strain GHA (Accession No. ATCC74250); strain ATP02 (Accession No. DSM 24665); strain PPRI 5339; strain PPRI 7315, strain R444, strains IL197, IL12, IL236, IL10, IL131, IL116; strain BaGPK; strain ICPE 279, strain CG 716; C2.6 Lecanicillium lecanii (formerly known as Verticillium lecanii), in particular conidia of strain KV01, strain DAOM198499 or strain DAOM216596; C2.9 Lecanicillium muscarium (formerly Verticillium lecanii), in particular strain VE 6/CABI(=IMI) 268317/CBS102071/ARSEF5128; C2.10 Metarhizium anisopliae var acridum, e.g. ARSEF324 or isolate IMI 330189 (ARSEF7486); C2.11 Metarhizium brunneum, e.g. strain Cb 15; C2.12 Metarhizium anisopliae, e.g. strain ESALQ 1037, strain E-9, strain M206077, strain C4-B (NRRL 30905), strain ESC1, strain 15013-1 (NRRL 67073), strain 3213-1 (NRRL 67074), strain C20091, strain C20092, strain F52 (DSM3884/ATCC 90448) or strain ICIPE 78; C2.14 Paecilomyces fumosoroseus (new: Isaria fumosorosea), in particular strains Apopka 97, Fe9901, ARSEF 3581, ARSEF 3302, ARSEF 2679, IfB01 (China Center for Type Culture Collection CCTCC M2012400), ESALQ1296, ESALQ1364, ESALQ1409, CG1228, KCH J2, HIB-19, HIB-23, HIB-29, HIB-30, CHE-CNRCB 304, EH-511/3, CHE-CNRCB 303, CHE-CNRCB 305, CHE-CNRCB 307, EH-506/3, EH-503/3, EH-520/3, PFCAM, MBP, PSMB1, RCEF3304, PF01-N10 (CCTCC No. M207088), CCM 8367, SFP-198, K3, CLO 55, IfTS01, IfT S02, IfTS07, P1, If-02, If-2.3, If-03, Ifr AsC, PC-013 (DSMZ 26931), P43A, PCC, P104, Pf59, Pf109, FG340, Pfr1, Pfr8, Pfr9, Pfr10, Pfr11, Pfr12, Ifr531, IF-1106, I9602, I7284, I03011 (Patent U.S. Pat. No. 4,618,578), CNRCB1, SCAU-IFCF01, PF01-N4, Pfr-612, Pf-Tim, Pf-Tiz, Pf-Hal and Pf-Tic.

It is particularly preferred that the fungal strain is Isaria fumosorosea, more preferably the strains as listed above. A particularly preferred strain is APOPKA97.

If the fungal spores or the fungus growing from said fungal spores have a nematicidal effect, it may be selected from

D2.1 Muscodor albus, in particular strain QST 20799 (Accession No. NRRL 30547); D2.2 Muscodor roseus, in particular strain A3-5 (Accession No. NRRL 30548); D2.3 Paecilomyces lilacinus (also known as Purpureocillium lilacinum), in particular P. lilacinus strain 251 (AGAL 89/030550; e.g. BioAct from Bayer CropScience Biologics GmbH); D2.4 Trichoderma koningii; D2.5 Harposporium anguillullae; D2.6 Hirsutella minnesotensis; D2.7 Monacrosporium cionopagum; D2.8 Monacrosporium psychrophilum; D2.9 Myrothecium verrucaria, in particular strain AARC-0255 (e.g. DiTera™ by Valent Biosciences); D2.10 Paecilomyces variotii, strain Q-09 (e.g. Nemaquim® from Quimia, MX); D2.11 Stagonospora phaseoli (e.g. from Syngenta); D2.12 Trichoderma lignorum, in particular strain TL-0601 (e.g. Mycotric from Futureco Bioscience, ES); D2.13 Fusarium solani, strain Fs5; D2.14 Hirsutella rhossiliensis; D2.15 Monacrosporium drechsleri; D2.16 Monacrosporium gephyropagum; D2.17 Nematoctonus geogenius; D2.18 Nematoctonus leiosporus; D2.19 Neocosmospora vasinfecta; D2.20 Paraglomus sp, in particular Paraglomus brasilianum; D2.21 Pochonia chlamydosporia (also known as Vercillium chlamydosporium), in particular var. catenulata (IMI SD 187; e.g. KlamiC from The National Center of Animal and Plant Health (CENSA), CU); D2.22 Stagonospora heteroderae; D2.23 Meristacrum asterospermum, D2.24 Duddingtonia flagrans.

In a more preferred embodiment, fungal strains with nematicidal effect are selected from Paecilomyces lilacinus, in particular spores of P. lilacinus strain 251 (AGAL 89/030550) (available as BioAct from Prophyta) and Duddingtonia flagrans.

If the fungal spores or the fungus growing from said fungal spores support and/or promote and/or stimulate plant health and plant growth they may be selected from

E2.1 Talaromyces flavus, in particular strain V117b; E2.2 Trichoderma atroviride, in particular strain no. V08/002387, strain no. NMI No. V08/002388, strain no. NMI No. V08/002389, strain no. NMI No. V08/002390, strain LC52 (e.g. Sentinel from Agrimm Technologies Limited), strain kd (e.g. T-Gro from Andermatt Biocontrol), and/or strain LUI32 (e.g. Tenet from Agrimm Technologies Limited); E2.3 Trichoderma harzianum, in particular strain ITEM 908 or T-22 (e.g. Trianum-P from Koppert); E2.4 Myrothecium verrucaria, in particular strain AARC-0255 (e.g. DiTera™ from Valent Biosciences); E2.5 Penicillium bilaii, in particular strain ATCC 22348, and/or strain ATCC20851 (e.g. JumpStart® from Monsanto BioAg); E2.6 Pythium oligandrum, in particular strains DV74 or M1 (ATCC 38472; e.g. Polyversum from Bioprepraty, CZ); E2.7 Rhizopogon amylopogon (e.g. comprised in Myco-Sol from Helena Chemical Company); E2.8 Rhizopogon fulvigleba (e.g. comprised in Myco-Sol from Helena Chemical Company); E2.9 Trichoderma harzianum, in particular strain TSTh20, strain KD, product Eco-T from Plant Health Products, ZA or strain 1295-22; E2.10 Trichoderma koningii; E2.11 Glomus aggregatum; E2.12 Glomus clarum; E2.13 Glomus deserticola; E2.14 Glomus etunicatum; E2.15 Glomus intraradices; E2.16 Glomus monosporum; E2.17 Glomus mosseae; E2.18 Laccaria bicolor; E2.19 Rhizopogon luteolus; E2.20 Rhizopogon tinctorus; E2.21 Rhizopogon villosulus; E2.22 Scleroderma cepa; E2.23 Suillus granulatus; E2.24 Suillus punctatapies; E2.25 Trichoderma vixens, in particular strain GL-21; and E2.26 Verticillium albo-atrum (formerly V. dahliae), in particular strain WCS850 (CBS 276.92; e.g. Dutch Trig from Tree Care Innovations).

In a more preferred embodiment, fungal strains having a beneficial effect on plant health and/or growth are selected from

Talaromyces flavus, strain VII7b; Trichoderma harzianum, in particular strain KD, strain ITEM 908 or strain T-22 Penicillium bilaii, in particular strain ATCC 22348, and/or strain ATCC20851; and Pythium oligandrum, strain DV74 or M1 (ATCC 38472).

In an even more preferred embodiment, fungal strains having a beneficial effect on plant health and/or growth are selected from Penicillium bilaii, in particular strain ATCC 22348 (available as JumpStart0 from Novozymes) and strain ATCC 22348 (available as PB-50 PROVIDE from Philom Bios Inc., Saskatoon, Saskatchewan).

If the fungal spores or the fungus growing from said fungal spores have a herbicidal effect they may be selected from

F2.1 Phoma macrostroma, in particular strain 94-44B; F2.2 Sclerotinia minor, in particular strain IMI 344141 (e.g. Sarritor by Agrium Advanced Technologies); F2.3 Colletotrichum gloeosporioides, in particular strain ATCC 20358 (e.g. Collego (also known as LockDown) by Agricultural Research Initiatives); F2.4 Stagonospora atriplicis; or F2.5 Fusarium oxysporum, different strains of which are active against different plant species, e.g. the weed Striga hermonthica (Fusarium oxysproum formae specialis strigae).

In a more preferred embodiment, said fungal spores originate from a fungal species selected from the group consisting of Isaria fumosorosea, Penicillium frequentans, Cladosporium cladosporioides, Cladosporium delicatum, Metarhizium brunneum, Beauveria bassiana, Beauveria brogniartii, Lecanicillium spp., Clonostachys rosea, Nomuraea rileyi, Trichoderma spp., Penicillium bilaii and Purpureocillium lilacinum.

In a preferred embodiment, said fungal spores originate from an entomopathogenic fungus, i.e. have insecticidal activity. These include the above-listed species such as Isaria fumosorosea, Metarhizium anisopliae, Beauveria bassiana, Beauveria brogniartii and Lecanicillium spp.

Beauveria bassiana is mass-produced and used to manage a wide variety of insect pests including whiteflies, thrips, aphids and weevils. Lecanicillium spp. is deployed against white flies, thrips and aphids. Metarhizium spp. is used against pests including beetles, locusts and other grasshoppers, Hemiptera, and spider mites. Isaria fumosorosea is effective e.g. against white flies, thrips and aphids.

In a more preferred embodiment, said fungal spores originate from the fungal species Isaria fumosorosea.

Preferred strains of Isaria fumosorosea are selected from the group consisting of Apopka 97, Fe9901, ARSEF 3581, ARSEF 3302, ARSEF 2679, IfB01 (China Center for Type Culture Collection CCTCC M2012400), ESALQ1296, ESALQ1364, ESALQ1409, CG1228, KCH J2, HIB-19, HIB-23, HIB-29, HIB-30, CHE-CNRCB 304, EH-511/3, CHE-CNRCB 303, CHE-CNRCB 305, CHE-CNRCB 307, EH-506/3, EH-503/3, EH-520/3, PFCAM, MBP, PSMB1, RCEF3304, PF01-N10 (CCTCC No. M207088), CCM 8367, SFP-198, K3, CLO 55, IfTS01, IfTS02, IfTS07, P1, If-02, If-2.3, If-03, Ifr AsC, PC-013 (DSMZ 26931), P43A, PCC, Pf04, Pf59, Pf109, FG340, Pfr1, Pfr8, Pfr9, Pfr10, Pfr11, Pfr12, Ifr531, IF-1106, I9602, I7284, I03011 (Patent U.S. Pat. No. 4,618,578), CNRCB1, SCAU-IFCF01, PF01-N4, Pfr-612, Pf-Tim, Pf-Tiz, Pf-Hal, Pf-Tic.

It is most preferred that said Isaria fumosorosea strain is selected from Apopka 97 and Fe9901.

Preferred strains of Beauveria bassiana include strain ATCC 74040; strain GHA (Accession No. ATCC74250); strain ATP02 (Accession No. DSM 24665); strain PPRI 5339; strain PPRI 7315, strains IL197, IL12, IL236, IL10, IL131, IL116, strain Bv025; strain BaGPK; strain ICPE 279, strain CG 716; ESALQPL63, ESALQ447 and ESALQ1432, CG1229, IMI389521, NPP111B005, Bb-147.

It is most preferred that Beauveria bassiana strains include strain ATCC 74040 and strain GHA (Accession No. ATCC74250).

The formulation according to the invention may further comprise an emulsifier, If used, the concentration of emulsifier is at least 1 wt.-%. Here, the maximum concentration of said at least one emulsifier should not exceed 30 wt.-%. Accordingly, useful ranges for emulsifiers range between 1 wt.-% and 20 wt.-%, and any value in between, preferably between 5 wt.-% and 15 wt.-%, more preferably between about 7.5 wt.-% and 12.5 wt.-%, such as about 9%, about 10% or about 11%.

Suitable emulsifiers include ethoxylated sorbitan esters, e.g. ethoxylated sorbitan trioleate 20EO, (e.g. Tween 85); ethoxylated sorbitan monooleate (e.g. Tween 80); ethoxylated sorbitan monolaurate (e.g. Emulsogen 4156, Tween 20); or ethoxylated sorbitol esters, e.g. ethoxylated sorbitol hexaoleate 40EO (e.g. Arlatone TV); ethoxylated sorbitol tetraoleate-laurate 40EO (e.g. Atlox 1045-A); or ethoxylated castor oils, e.g. Emulsogen EL400, Emulsogen EL360, Emulsogen EL300, Lucramul CO30, Agnique CSO25 or Etocas 10. These emulsifiers are preferably present in a range of between about 7.5 wt.-% and 12.5 wt.-%, such as about 9%, about 10% or about 11%.

In a preferred embodiment, said emulsifier is an ethoxylated sorbitol ester, such as ethoxylated sorbitol hexaoleate 40EO.

In another preferred embodiment, said emulsifiers are combined with other emulsifiers such as ethoxylated alcohols or propoxylated-ethoxylated alcohols. These substances are best described by the general formula X—O—[CH₂—CH(CH₃)—O]ₘ—[CH₂—CH₂—O—]ₙ—OH where X is a branched or linear alcohol, saturated or partially unsaturated, with 1-24 carbon atoms, preferably 2-18, more preferably 3-14, most preferably 4-10, wherein m is an average number between 0 and 20, preferably 0-15; more preferably 0-10, and wherein n is an average number between 1 and 20, preferably 2-15, more preferably 3-10. These emulsifiers are preferably present in a range of between about 0-10%.

An exemplary advantageous formulation according to the invention comprises

0.05 to 10 wt.-% fungal spores

27 to 93.93 wt.-% plant oil, such as soybean oil

0.1 to 1 wt.-% antioxidant, such as BHT

5 to 30 wt.-% BreakThru S240

1 to 30 wt.-% emulsifier, such as an ethoxylated sorbitol ester, such as ethoxylated sorbitol hexaoleate 40EO, or an ethoxylated castor oil, optionally in combination with an ethoxylated alcohol or propoxylated-ethoxylated alcohol, or a mixture of any of the foregoing

0 to 5 wt.-% rheology-modifying agent, such as fumed silica, in particular fumed silica having a BET surface area of about 200 m²/g, such as Aerosil 200.

In a preferred embodiment, where said fungal spores originate from the fungal species Isaria fumosorosea, the formulation comprises

1.5 to 5 wt.-%, preferably about 3 wt.-% fungal spores

63 to 87.3 wt.-%, preferably 75 wt.-% to 83 wt.-% plant oil, such as soybean oil

0.2 to 1 wt.-%, preferably 0.5 wt.-% to 0.7 wt.-% of at least one antioxidant, such as BHT

5 to 15 wt.-%, preferably 7.5 wt.-% to 12.5 wt.-% BreakThru S240

5 to 15 wt.-%, preferably 7.5 wt.-% to 12.5 wt.-% of at least one emulsifier, such as an ethoxylated sorbitol ester, such as ethoxylated sorbitol hexaoleate 40E0, or an ethoxylated castor oil, and optionally in addition thereto an ethoxylated alcohol or and propoxylated-ethoxylated alcohol, or a mixture of any of the foregoing 0 to 3 wt.-%, preferably 2 wt.-% to 3 wt.-% of at least one rheology-modifying agent, such as fumed silica, in particular fumed silica having a BET surface area of about 200 m²/g, such as Aerosil 200.

In a preferred embodiment in connection with the formulation of the present invention, the formulation does not comprise ferulic acid or salts thereof including feruloylated fatty acids or triglycerides.

In a further aspect, the present invention relates to a method for controlling phytopathogenic fungi, insects and/or nematodes in or on a plant, for enhancing growth of a plant or for increasing plant yield or root health comprising applying an effective amount of the formulation according to the invention as described above to said plant or to a locus where plants are growing or intended to be grown.

In another embodiment the present invention relates to the use of a formulation as disclosed herein for controlling phytopathogenic fungi, insects and/or nematodes in, on and/or around a plant, for enhancing growth of a plant or for increasing plant yield or root health.

Plants which can be treated in accordance with the invention include the following main crop plants: maize, soya bean, alfalfa, cotton, sunflower, Brassica oil seeds such as Brassica napus (e.g. canola, rapeseed), Brassica rapa, B. juncea (e.g. (field) mustard) and Brassica carinata, Arecaceae sp. (e.g. oilpalm, coconut), rice, wheat, sugar beet, sugar cane, oats, rye, barley, millet and sorghum, triticale, flax, nuts, grapes and vine and various fruit and vegetables from various botanic taxa, e.g. Rosaceae sp. (e.g. pome fruits such as apples and pears, but also stone fruits such as apricots, cherries, almonds, plums and peaches, and berry fruits such as strawberries, raspberries, red and black currant and gooseberry), Ribesioidae sp., Juglandaceae sp., Betulaceae sp., Anacardiaceae sp., Fagaceae sp., Moraceae sp., Oleaceae sp. (e.g. olive tree), Actinidaceae sp., Lauraceae sp. (e.g. avocado, cinnamon, camphor), Musaceae sp. (e.g. banana trees and plantations), Rubiaceae sp. (e.g. coffee), Theaceae sp. (e.g. tea), Sterculiceae sp., Rutaceae sp. (e.g. lemons, oranges, mandarins and grapefruit); Solanaceae sp. (e.g. tomatoes, potatoes, peppers, capsicum, aubergines, tobacco), Liliaceae sp., Compositae sp. (e.g. lettuce, artichokes and chicory—including root chicory, endive or common chicory), Umbelliferae sp. (e.g. carrots, parsley, celery and celeriac), Cucurbitaceae sp. (e.g. cucumbers—including gherkins, pumpkins, watermelons, calabashes and melons), Alliaceae sp. (e.g. leeks and onions), Cruciferae sp. (e.g. white cabbage, red cabbage, broccoli, cauliflower, Brussels sprouts, pak choi, kohlrabi, radishes, horseradish, cress and chinese cabbage), Leguminosae sp. (e.g. peanuts, peas, lentils and beans—e.g. common beans and broad beans), Chenopodiaceae sp. (e.g. Swiss chard, fodder beet, spinach, beetroot), Linaceae sp. (e.g. hemp), Cannabeacea sp. (e.g. cannabis), Malvaceae sp. (e.g. okra, cocoa), Papaveraceae (e.g. poppy), Asparagaceae (e.g. asparagus); useful plants and ornamental plants in the garden and woods including turf, lawn, grass and Stevia rebaudiana; and in each case genetically modified types of these plants.

The amount of the formulation according to the invention when brought to the field, i.e. after dispersal in water, is at least 0.05 l/ha (hectare), such as 0.05 to 3 l/ha, 0.5 to 1.5 l/ha, such as 0.1, 0.2, 0.3, 0.4, 0.5, 0.6, 0.7, 0.75, 0.8, 0.9, 1.0, 1.1, 1.2, 1.3, 1.4 or 1.5 l/ha. In one embodiment where the formulation comprises Isaria fumosorosea spores for insect control, the amount to the field preferably ranges between 0.5 and 1 l/ha, the exact rate being dependent on the spore concentration in the formulation which is preferably between 5×10⁹ and 1×10¹⁰ spores/g formulation, e.g. for soil or foliar application.

The present invention also relates to the use of the formulation as disclosed herein in agriculture.

Use of the formulation of any one of claims 1 to 19, wherein said formulation does not comprise fungal spores, for enhancing storage stability of fungal spores. The skilled person is able to calculate the concentrations of ingredients of this blank formulation based on those given for the complete formulation including fungal spores.

The examples further illustrate the invention in a non-limiting fashion.

### EXAMPLE 1

### Superior Short Time Stability of Fungal Conidia in Pure Plant Oils Containing High Natural Amounts of Antioxidant

Different plant oils and one polyether-modified trisiloxane were mixed with conidia either of Penicillium frequentans (P.f.) or Isaria fumosorosea (I.f.). Penicillium frequentans conidia were mixed in a way that 8.47 g conidia powder (about 1×10¹² conidia) were blended into 91.53 g of each carrier using an Ultra Turrax for 1 min at 5400 rpm. Isaria fumosorosea conidia were mixed in a way that 3 g conidia powder (about 1×10¹² conidia) were blended into 97 g of each carrier using an Ultra Turrax for 1 min at 5400 rpm. The resulting conidia suspensions contained approximately 1×10¹⁰ conidia per gram. 10 ml of the liquid mixtures were then filled into 20 ml glass bottles, top sealed and incubated at 30° C. (Table 1). The high incubation temperature was used to simulate ageing and to make results available more quickly. To evaluate the compatibility between fungal conidia and liquid carrier the viability was determined using a microbiological counting method, i.e., 100 μl of a spore suspension with approximately 5×10⁶ conidia ml⁻¹ were plated on PDA (potato dextrose agar). The viability of conidia was evaluated by counting the number of germinated and non-germinated conidia among 200 counts after approximately 20 h incubation at 20° C. or 25° C. in two repetitions.

TABLE 1
Viability of conidia of Pencillium frequentans (P.f.) and
Isaria fumosorosea (I.f.) blended in different liquid carriers
and stored at 30° C. under controlled conditions.

| | | Conidial viability [%] after | |
|---|---|---|---|
| | | incubation at 30° C. after | |
| Liquid Carrier: | Species | 0 weeks | 4 weeks |
| Wheat germ oil | P.f. | 96 | 92 |
| Soy bean oil | P.f. | 96 | 83 |
| polyether-modified trisiloxane | P.f. | 96 | 80 |
| Wheatgerm oil | I.f. | 92 | 77 |
| Soy bean oil | I.f. | 93 | 79 |
| Rapeseed oil | I.f. | 95 | 66 |
| Codacide oil | I.f. | 96 | 65 |
| Corn oil | I.f. | 96 | 72 |
| Sunflower oil | I.f. | 95 | 66 |
| Polyether-modified trisiloxane | I.f. | 90 | 52 |

Result: The viability of the conidia significantly depends on the choice of liquid carrier. Using conidia of Penicillium frequentans wheat germ oil gave the best result after storage for 4 weeks at 30° C. Wheat germ oil and soybean oil were found to be the most suitable liquid carriers for Isaria fumosorosea.

### EXAMPLE 2

### Influence of an Antioxidant on the Viability of Fungal Spores Mixed with a Liquid Plant Oil

The result of Example 1 led to the assumption that high levels of natural antioxidants within wheat germ oil may positively prolong the viability of fungal conidia. The next experiment was designed to evaluate whether adding an additional antioxidant could further prolong the viability and therefore broaden the use-spectrum towards other plant oils.

A test was carried out using wheat germ oil as a control and soy bean oil mixed with different ratios of butylhydroxytoluol (BHT): 99.4:0.6 and 99.8:0.2. In parallel it was assessed whether a ratio of polyether-modified trisiloxane and BHT of 99.4:0.6 can increase the viability of conidia in this liquid. BHT was mixed into the liquid carrier applying an Ultra Turrax at 6000 rpm until it was totally dissolved. The resulting liquids then were prepared and evaluated as described in Example 1. The first tests were carried out at a storage temperature of 40° C. (Table 2) and 30° C. (Table 3). At each time point a new sample was opened and used.

TABLE 2
Viability of conidia of Penicillium frequentans mixed with
different liquids and ratios of antioxidants. Storage at 40° C.

| | | | Conidial viability | |
|---|---|---|---|---|
| | | | [%] after incubation | |
| | Ratio | | at 40° C. after | |
| Carrier | carrier:antioxidant | Species | 0 weeks | 4 weeks |
| Wheat germ oil | n.a. | P.f. | 96 | 41 |
| Soy bean oil | 99.4:0.6 | P.f. | 94 | 39 |
| Soy bean oil | 99.8:0.2 | P.f. | 93 | 37 |
| Soy bean oil | n.a. | P.f. | 94 | 28 |
| Polyether-modified | 99.4:0.6 | P.f. | 88 | 28 |
| trisiloxane | | | | |
| Polyether-modified | n.a. | P.f. | 88 | 30 |
| trisiloxane | | | | |

Result: Penicillium frequentans conidia stored at 40° C. showed the highest viability after 4 weeks when using wheat germ oil, 41% compared to 28% using soy bean oil only. The addition of BHT to soy bean oil could increase the conidial viability to nearly the same level as the control. With the tested concentration no effect was observed using Polyether-modified trisiloxane.

A similar set up was used to evaluate the influence of BHT on the survival of conidia from Isaria fumosorosea. Soy bean oil was mixed with BHT in a ratio of: 95:5; 98:2; 99:1; 99.4:0.6 and 99.8:0.2 and mixed with fungal conidia in the same way as described previously. The mixtures were stored for 12 weeks at 30° C. (Table 3).

TABLE 3
Conidial viability of Penicillium frequentans (P.f.)
and Isaria fumosorosea (I.f.) mixed with different
liquids and ratios of antioxidants. Storage at 30° C.

| | | | Conidial viability | | | |
|---|---|---|---|---|---|---|
| | | | [%] after incubation | | | |
| | Ratio | | at 30° C. after (weeks) | | | |
| Carrier | carrier:antioxidant | Species | 0 | 4 | 8 | 12 |
| Wheat germ oil | n.a. | P.f. | 96 | 76 | 71 | n.t. |
| Soy bean oil | 99.4:0.6 | P.f. | 94 | 78 | 58 | n.t. |
| Soy bean oil | 99.8:0.2 | P.f. | 93 | 68 | 63 | n.t. |
| Soy bean oil | n.a. | P.f. | 94 | 70 | 60 | n.t. |
| Polyether-modified | 99.4:0.6 | P.f. | 88 | 56 | 54 | n.t. |
| trisiloxane | | | | | | |
| Polyether-modified | n.a. | P.f. | 88 | 55 | 55 | n.t. |
| trisiloxane | | | | | | |
| Soy bean oil | 95:5 | I.f. | 96 | 75 | 61 | 44 |
| Soy bean oil | 98:2 | I.f. | 95 | 75 | 58 | 47 |
| Soy bean oil | 99:1 | I.f. | 93 | 91 | 52 | 45 |
| Soy bean oil | 99.4:0.6 | I.f. | 91 | 83 | 73 | 49 |
| Soy bean oil | 99.8:0.2 | I.f. | 93 | 79 | 67 | 51 |
| Soy bean oil | n.a. | I.f. | 95 | 76 | 57 | 52 |

Result: The combination of soy bean oil with BHT in a ratio of 99.4:0.6 together with conidia of Penicillium frequentans led to an 8% viability increase as compared to soy bean oil only, when measured after a storage time of four weeks at 30° C. This viability was at the same level than the control wheat germ oil. No difference within the group of soy bean oil was detectable after eight weeks, whereas conidia mixed with wheat germ oil maintained a good viability. The Addition of BHT temporarily increased the stability of the conidia in soy bean oil

The positive temporary effect of BHT was also observed when conidia of Isaria fumosorosea were used. Conidial viability after 4 weeks was increased when soy bean oil was blended with BHT in a ratio of 99:1; 99.4:0.6 and 99.8:0.2.

### EXAMPLE 3

### Influence of an Antioxidant on the Viability of Fungal Spores Mixed with Alternative Liquid Plant Oil

Further plant oils with added antioxidant were tested with a setup as described in Example 2.

TABLE 4a
Conidial viability of Isaria fumosorosea (I.f.) mixed with Sunflower oil
or Rapeseed oil and different ratios of antioxidants. Storage at 30° C.

| | Ratio | | Conidial viability [%] | | | |
|---|---|---|---|---|---|---|
| Carrier | oil:antioxidant | Species | 0 weeks | 4 weeks | 8 weeks | 12 weeks |
| Sunflower oil | 95:5 | I.f. | 98 | 95 | 91 | 78 |
| Sunflower oil | 98:2 | I.f. | 97 | 95 | 91 | 85 |
| Sunflower oil | 99:1 | I.f. | 98 | 92 | 90 | 79 |
| Sunflower oil | 99.4:0.6 | I.f. | 99 | 96 | 85 | 77 |
| Sunflower oil | 99.8:0.2 | I.f. | 98 | 92 | 89 | 82 |
| Sunflower oil | n.a. | I.f. | 99 | 91 | 87 | 76 |
| Rapeseed oil | 95:5 | I.f. | 98 | 96 | 94 | 84 |
| Rapeseed oil | 98:2 | I.f. | 98 | 95 | 94 | 89 |
| Rapeseed oil | 99:1 | I.f. | 98 | 96 | 94 | 90 |
| Rapeseed oil | 99.4:0.6 | I.f. | 97 | 96 | 93 | 88 |
| Rapeseed oil | 99.8:0.2 | I.f. | 99 | 97 | 91 | 81 |
| Rapeseed oil | n.a. | I.f. | 98 | 95 | 94 | 85 |
| Soy bean oil | n.a. | I.f. | 98 | 93 | 93 | 90 |

TABLE 4b
Conidial viability of Isaria fumosorosea (I.f.)
mixed with Sunflower oil or Rapeseed oil and different
ratios of antioxidants. Storage at 40° C.

| | | | Conidial viability | | |
|---|---|---|---|---|---|
| | | | [%] after incubation | | |
| | Ratio | | at 40° C. after (weeks) | | |
| Carrier | oil:antioxidant | Species | 0 | 4 | 5 |
| Sunflower oil | 95:5 | I.f. | 98 | 50 | 17 |
| Sunflower oil | 98:2 | I.f. | 97 | 55 | 37 |
| Sunflower oil | 99:1 | I.f. | 98 | 53 | 35 |
| Sunflower oil | 99.4:0.6 | I.f. | 99 | 51 | 25 |
| Sunflower oil | 99.8:0.2 | I.f. | 98 | 61 | 42 |
| Sunflower oil | n.a. | I.f. | 99 | 50 | 31 |
| Rapeseed oil | 95:5 | I.f. | 98 | 60 | 47 |
| Rapeseed oil | 98:2 | I.f. | 98 | 61 | 49 |
| Rapeseed oil | 99:1 | I.f. | 98 | 70 | 51 |
| Rapeseed oil | 99.4:0.6 | I.f. | 97 | 71 | 47 |
| Rapeseed oil | 99.8:0.2 | I.f. | 99 | 60 | 44 |
| Rapeseed oil | n.a. | I.f. | 98 | 66 | 44 |
| Soy bean oil | n.a. | I.f. | 98 | 69 | 59 |

Result: Similar effects of BHT were detected when using sunflower oil and rapeseed oil.

### EXAMPLE 4

### Assessment of Combinational Effects: Influence of Different Concentrations of a Fumed Silica Stabilizer and an Antioxidant Within Plant Oil on the Viability of Conidia from Penicillium frequentans

A test was carried out using pure soy bean oil as control and four different mixtures of soy bean oil with fumed silica. To create the mixtures the following ratios of soy bean oil and fumed silica (Aerosil 200) have been used: 98:2; 97.5:2.5; 97:3; 96.5:3.5. Aerosil 200 was mixed into Soy bean oil applying an Ultra Turrax for 10 min at 10,000 rpm and further 5 min at 5600 rpm. The five liquids then were mixed with Penicillium frequentans conidia powder in a way that 8.47 g conidia powder (about 1×10¹² conidia) were blended into 91.53 g of each liquid using an Ultra Turrax for 1 min at 5400 rpm. The resulting conidia suspensions contained approximately 1×10¹⁰ conidia per gram. 20 ml of liquid mixtures then were filled into 20 ml glass bottles, top sealed and incubated at 30° C. to evaluate the influence of the stabilizer concentration on the conidial viability (Table 5). At each time point a new sample was opened and used.

TABLE 5
Conidial viability of Penicillium frequentans
mixed with soy bean oil and soy bean oil blended
with Aerosil 200 (stabilizer), Storage at 30° C.

| | | Conidial viability | | |
|---|---|---|---|---|
| | Ratio | [%] after (weeks) | | |
| | oil:antioxidant | 0 | 4 | 6 |
| Soy bean oil | n.a. | 92 | 73 | 66 |
| Soy bean oil blended with | 98.0:2.0 | 98 | 77 | 70 |
| Aerosil 200 | | | | |
| Soy bean oil blended with | 97.5:2.5 | 98 | 79 | 67 |
| Aerosil 200 | | | | |
| Soy bean oil blended with | 97.0:3.0 | 98 | 81 | 73 |
| Aerosil 200 | | | | |
| Soy bean oil blended with | 96.5:3.5 | 98 | 81 | 74 |
| Aerosil 200 | | | | |

Result: The addition of the fumed silica Aerosil 200 has no negative effect on the viability of the conidia, it clearly supports the viability.

The next experiment focused on the combinational effect of a stabilizer and an antioxidant (Table 6). Soy bean oil was blended with BHT in a ratio of 98:2; 99:1 and 99.4:0.6 as described in example 2 followed by the incorporation of fumed silica in a ratio of 98:2 and conidia of Penicillium frequentans as described previously.

TABLE 6
Influence of stabilizer and antioxidant on conidial viability of Penicillium frequentans
mixed with soy bean oil, Storage temperature 30° C.

| | Ratio | Ratio | Conidial viability | | | |
|---|---|---|---|---|---|---|
| | oil:antioxidant | carrier:fumed | [%] after (weeks) | | | |
| | (→ carrier) | silica | 0 | 4 | 6 | 8 |
| Soy bean oil | n.a. | n.a. | 92 | 73 | 66 | 55 |
| Soy bean oil blended with | n.a. | 98.0:2.0 | 98 | 77 | 70 | n.t. |
| Aerosil 200 | | | | | | |
| Soy bean oil blended with | 98.0:2.0 | 98.0:2.0 | 95 | 85 | 73 | 68 |
| Aerosil 200 + BHT | | | | | | |
| Soy bean oil blended with | 99.0:1.0 | 98.0:2.0 | 96 | 86 | 73 | 68 |
| Aerosil 200 + BHT | | | | | | |
| Soy bean oil blended with | 99.4:0.6 | 98.0:2.0 | 96 | 89 | 71 | 65 |
| Aerosil 200 + BHT | | | | | | |

Result: The combination of a stabilizer and an antioxidant has a positive effect on the conidial stability. Effects are clearly seen after 4 weeks and 8 weeks were the viability is 89% and 65% compared to the control with 73% and 55%, respectively.

### EXAMPLE 5

### Assessment of Combinational Effects: Influence of a Fumed Silica Stabilizer and Different Concentrations of an Antioxidant on the Viability of Fungal Conidia

A similar test as described in Example 4 was carried out with conidia of Isaria fumosorosea. Conidia were mixed in a way that 3 g conidia powder (about 1×10¹² conidia) were blended into 97 g of soy bean oil or soy bean oil containing fumed silica in a ratio of 97.5:2.5 and/or an antioxidant in a ratio of 95:5; 98:2, 99:1; 99.4:0.6 and 99.8:0.2 using an Ultra Turrax as described in Example 4. The resulting mixtures contained approximately 1×10¹⁰ conidia per gram and were filled into 20 ml bottles and stored for 8 weeks at 30° C. The viability was regularly checked as described in Example 1. At each time point a new samples was opened and used.

TABLE 7
Viability of Isaria fumosorosea conidia mixed with fumed silica and
different concentrations of an antioxidant. Storage temperature 30° C.

| | Ratio | Ratio of | Conidial viability | | |
|---|---|---|---|---|---|
| | plant oil:antioxidant | carrier:fumed | [%] after (weeks) | | |
| | (→carrier) | silica | 0 | 4 | 8 |
| Soy bean oil | n.a. | n.a. | 84 | 78 | 69 |
| Soy bean oil blended with | n.a. | 97.5:2.5 | 92 | 76 | 74 |
| Aerosil 200 | | | | | |
| Soy bean oil blended with | 95.0:5.0 | 97.5:2.5 | 84 | 72 | 74 |
| Aerosil 200 + BHT | | | | | |
| Soy bean oil blended with | 98.0:2.0 | 97.5:2.5 | 78 | 72 | 81 |
| Aerosil 200 + BHT | | | | | |
| Soy bean oil blended with | 99.0:1.0 | 97.5:2.5 | 83 | 80 | 78 |
| Aerosil 200 + BHT | | | | | |
| Soy bean oil blended with | 99.4:0.6 | 97.5:2.5 | 84 | 77 | 76 |
| Aerosil 200 + BHT | | | | | |
| Soy bean oil blended with | 99.8:0.2 | 97.5:2.5 | 83 | 78 | 74 |
| Aerosil 200 and BHT | | | | | |

Result: The test confirmed the result of Example 4. An increased viability can be obtained when fumed silica combined with an antioxidant and suitable plant oil is used in a mixture to protect e.g. fungal conidia of Isaria fumosorosea.

### EXAMPLE 6

### One Year Storage Stability Test of Different Formulations Containing Conidia of Isaria fumosorosea at Increased Temperatures

Long term storage stability of fungal conidia mixed into a formulation according to the invention was evaluated and compared with formulations based on whiteoil. First the antioxidant was mixed into soybean oil applying an Ultra Turrax at 6000 rpm until it was completely dissolved. Then a surfactant based on a polyether-modified trisiloxane (Break Thru S240, to a concentration of about 10%) and at least one emulsifier (ethoxylated sorbitol ester, to a concentration of about 10%) were homogenized with the suspension using an Ultra Turrax for 10 min at 8000 rpm before conidia of Isaria fumosorosea were included as described in Example 1. Tests were carried out in comparison to three different white-oil (Catenex) based formulations (differences in used surfactant and emulsifiers). The viability over time was evaluated as described in Example 1. Fives dates 0, 3, 6, 9 and 12 month were assed when stored at 20° C. (Table 8) and five dates 0, 1, 3, 6 and 9 month when stored at 30° C. (Table 9). At each date a new samples was opened and evaluated.

TABLE 8
One year comparison of five different liquid formulations
based on conidia of Isaria fumosorosea stored at 20° C.

Conidial viability [%]

| Time | Soybean | Whiteoil- | Whiteoil- | Whiteoil- |
|---|---|---|---|---|
| [month] | oil-based | based 1.1 | based 1.2 | based 1.3 |
| 0 | 98 | 98 | 98 | 98 |
| 3 | 98 | 98 | 94 | 97 |
| 6 | 77 | 66 | 86 | 75 |
| 9 | 85 | 65 | 86 | 81 |
| 12 | 90 | 72 | 93 | 87 |

TABLE 9
Nine month comparison of five different liquid formulations
based on conidia of Isaria fumosorosea stored at 30° C.

Conidial viability [%]

| | Soy bean- | | | |
|---|---|---|---|---|
| Time | based | Whiteoil | Whiteoil | Whiteoil |
| [month] | (invention) | based 1.1 | based 1.2 | based 1.3 |
| 0 | 98 | 98 | 98 | 98 |
| 1 | 89 | 81 | 94 | 89 |
| 3 | 86 | 83 | 83 | 85 |
| 6 | 75 | 23 | 76 | 51 |
| 9 | 45 | 11 | 21 | 18 |

The result clearly shows that conidia of Isaria fumosorosea combined with the formulation composition described in the invention shows the best storage stability so far recorded. Conidia are viable after 1 year of storage at room temperature (20° C.) and for at least six month at an elevated temperature of 30° C.

### EXAMPLE 7

### Applicability of the Invention to Conidia of Different Fungal Species

Beside conidia of Isaria fumosorosea the compatibility of the formulation with conidia from different fungal species was tested. The formulation was prepared as described in Example 6. Conidia of Penicillium frequentans (P.f.) were mixed with the formulation in a way as described in Example 1. Cladosporium delicatulum (C.d.) conidia were mixed in a way that 11.12 g conidia powder (5×10¹¹ conidia) were blended into 88.88 g of the formulation described in the invention using an Ultra Turrax for 1 min at 5400 rpm. Cladosporium cladosporioides (C.c.) conidia were mixed in a way that 7.33 g conidia powder (5×10¹¹) conidia were blended into 92.67 g formulation using an Ultra Turrax for 1 min at 5400 rpm. The resulting mixture contained approximately 5×10⁹ conidia per gram. 20 ml of the liquid mixtures were then filled into 20 ml glass bottles, top sealed and incubated at 20° C. for one year. At each date a new sample was opened and evaluated as described in Example 1.

TABLE 10
Alternative fungi, 20° C.

| Time | Conidial viability [%] | | |
|---|---|---|---|
| [month] | P.f. | C.c. | C.d. |
| 0 | 96 | 74 | 88 |
| 1 | 85 | n.t. | n.t. |
| 3 | 92 | n.t. | n.t. |
| 6 | 89 | 60 | 70 |
| 9 | 83 | n.t. | n.t. |
| 12 | 84 | 55 | 65 |

Result: Example 7 clearly shows that spores of multiple fungal species are compatible with the present composition.

1. A liquid water-soluble agricultural formulation comprising fungal spores, at least 25 wt.-% of at least one plant oil, at least 0.1 wt.-% of at least one antioxidant and optionally up to 7 wt.-% of at least one rheology-modifying agent.

2. The formulation according to claim 1, wherein said plant oil is selected from the group consisting of wheat germ oil, soybean oil, peanut oil, rice bran oil, safflor oil, rapeseed oil, sunflower oil, corn oil, walnut oil, hazelnut oil, almond oil, and olive oil.

3. The formulation according to claim 1, wherein said plant oil is soybean oil.

4. The formulation according to claim 1, wherein the antioxidant is selected from the group consisting of butylhydroxytoluol, butylhydroxyanisole, ascorbyl palmitate, tocopheryl acetate, ascorbyl stearate, carotinoids, and gallates.

5. The formulation according to claim 1, wherein said antioxidant is butylhydroxytoluol.

6. The formulation according to claim 1, wherein said antioxidant is present in a concentration of between 0.1 wt.-% and 5 wt.-%.

7. The formulation according to claim 1, which is essentially free of water.

8. The formulation according to claim 1, wherein said fungal spores are conidia.

9. The formulation according to claim 1, wherein said fungal spores originate from an entomopathogenic fungus.

10. The formulation according to claim 1, wherein said fungal spores originate from a fungal species selected from the group consisting of Isaria fumosorosea, Penicillium frequentans, Cladosporium cladosporioides, Cladosporium delicatum, Metarhizium brunneum, Lecanicillium spp., Beauveria brogniartii, Clonostachys rosea, Nomuraea rileyi, Trichoderma spp., Beauveria bassiana, Penicillium bilaii and Purpureocillium lilacinum.

11. The formulation according to claim 1, wherein said fungal spores originate from the fungal species Isaria fumosorosea.

12. The formulation according to claim 11, wherein said Isaria fumosorosea is a strain selected from the group consisting of Apopka 97, Fe9901, ARSEF 3581, ARSEF 3302, ARSEF 2679, IfB01, ESALQ1296, ESALQ1364, ESALQ1409, CG1228, KCH J2, HIB-19, HIB-23, HIB-29, HIB-30, CHE-CNRCB 304, EH-511/3, CHE-CNRCB 303, CHE-CNRCB 305, CHE-CNRCB 307, EH-506/3, EH-503/3, EH-520/3, PFCAM, MBP, PSMB1, RCEF3304, PF01-N10, CCM 8367, SFP-198, K3, CLO 55, IfTS01, IfTS02, IfTS07, P1, If-02, If-2.3, If-03, Ifr AsC, PC-013, P43A, PCC, Pf04, Pf59, Pf109, FG340, Pfr1, Pfr8, Pfr9, Pfr10, Pfr11, Pfr12, Ifr531, IF-1106, I9602, I7284, I03011, CNRCB1, SCAU-IFCF01, PF01-N4, Pfr-612, Pf-Tim, Pf-Tiz, Pf-Hal, and Pf-Tic.

13. The formulation according to claim 1, wherein the concentration of fungal spores is at least 1×10⁵ viable spores/g formulation.

14. The formulation according to claim 1, wherein the concentration of fungal spores is at least 1×10⁷ wt.-% viable spores/g formulation.

15. The formulation according to claim 1, further comprising a polyether-modified trisiloxane.

16. The formulation according to claims 15, wherein said polyether-modified trisiloxane is Breakthru S240.

17. The formulation according to claim 1, further comprising at least 1 wt.-% of at least one emulsifier.

18. The formulation according to claim 17, wherein said emulsifier is selected from the group consisting of ethoxylated sorbitan esters, ethoxylated sorbitan monooleate;
ethoxylated sorbitan monolaurate, ethoxylated sorbitol esters, ethoxylated sorbitol tetraoleate-laurate, and ethoxylated castor oils.

19. The formulation according to claim 1, wherein said rheology-modifying agent is selected from the group consisting of fumed hydrophobic silica, fumed hydrophilic silica and precipitated silica.

20. The formulation according to claim 1, wherein said rheology-modifying agent is Aerosil 200.

21. The formulation according to claim 1, comprising
0.05 to 10 wt.-% fungal spores;
27 to 93.93 wt.-% plant oil;
0.02 to 1 wt.-% of at least one antioxidant;
0 to 30 wt.-% BreakThru S240;
1 to 30 wt.-% of at least one emulsifier; and
0 to 5 wt.-% of at least one rheology-modifying agent.

22. The formulation according to claim 1, wherein said fungal spores originate from the fungal species Isaria fumosorosea, comprising
1.5 to 5 wt.-% fungal spores;
63 to 87.3 wt.-% plant oil;
0.2 to 1 wt.-% of at least one antioxidant;
5 to 15 wt.-% BreakThru S240;
5 to 15 wt.-% of at least one emulsifier; and
1 to 3 wt.-% of at least one rheology-modifying agent.

23. The formulation according to claim 1, wherein the plant oil is soybean oil and the fungal conidia are from the species Isaria fumosorosea.

24. The formulation according to claim 23, wherein the antioxidant is butylhydroxytoluol and wherein the optional rheology modifier is Aerosil 200.

25. The formulation according to claim 23, further comprising a polyether-modified trisiloxane.

26. A method for controlling phytopathogenic fungi, insects and/or nematodes in or on a plant, for enhancing growth of a plant or for increasing plant yield or root health comprising applying an effective amount of the formulation according to claim 1.

27. (canceled)
